(19) United States
(12) Patent Application Publication
(10) Pub. No.: US 2013/0050286 A1
(43) Pub. Date: Feb. 28, 2013

(54) DRIVING CIRCUIT, DISPLAY, AND METHOD OF DRIVING THE DISPLAY

(71) Applicants: Tomoro Yoshinaga, Kanagawa (JP); Taro Ichitsubo, Tokyo (JP)

(72) Inventors: Tomoro Yoshinaga, Kanagawa (JP); Taro Ichitsubo, Tokyo (JP)

(73) Assignee: Sony Corporation, Tokyo (JP)

(21) Appl. No.: 13/567,675

(22) Filed: Aug. 6, 2012

(30) Foreign Application Priority Data
Aug. 31, 2011 (JP) 2011-189926

(51) Int. Cl. G09G 3/36; G09G 5/10

(52) U.S. Cl. 345/690; 345/89

(57) ABSTRACT

There is provided a driving circuit driving pixels in a display, the pixels each including a liquid crystal cell and a memory. The driving circuit includes: a dividing section dividing one frame period into subfields, the subfields corresponding to respective bits of gray-scale data and having period lengths commensurate with weights of the corresponding bits; a correction section correcting, when bit sequences of two sets of gray-scale data corresponding to two pixels adjacent to each other differ from each other, gray-scale data having a higher gray-scale level out of the two set of gray-scale data, to further increase the gray-scale level thereof; and an ON-OFF period control section controlling a ratio of an ON period or an OFF period to one frame period by bringing the liquid crystal cell of the pixel into an on state or an off state according to a corresponding bit in each of the subfields.

### BACKGROUND

The present technology relates to a driving circuit that performs gray-scale display by pulse-width modulation (PWM), and a display including the driving circuit. In addition, the present technology relates to a method of driving the above-mentioned display.

In digital displays that perform gray-scale display by PWM, a gray-scale display method as illustrated in FIG. 8 is used in an exemplary case of 5 bits (32 gray-scale levels), for example. Specifically, as illustrated in FIG. 8, with 1 bit data of several ms width taken as a unit for example, five pieces of data having a period length ratio of 1:2:4:8:16 are prepared, and 32 gray-scale levels are expressed by a combination of these five pieces of data.

FIG. 9 shows a relationship between signal data of sequential scanning and selection pulses applied to scan lines in known general digital driving. FIG. 9 shows a case of three scan lines for convenience of description. As is clear from FIG. 9, in a known general digital display, one frame period (1F) is divided into subfields SF1 to SF5 corresponding to respective bits (in this example, a first bit to a fifth bit) of gray-scale data, and having period lengths commensurate with the weights of the corresponding bits. In this configuration, an electro-optical device of a pixel is turned on or off according to the corresponding bit in each of the subfields SF1 to SF5, and thus a ratio of ON period or OFF period to 1F is stepwisely controlled. Further, data is written in pixels through scan lines by line-sequential scanning in each of the subfields SF1 to SF5. It is to be noted that, information on the above-mentioned digital driving is described in Japanese Unexamined Patent Application Publication No. 2006-343609 and the like, for example.

### SUMMARY

Incidentally, in the case where a gray-scale display method is used in which a phase of black and white is inverted according to a small difference of gray-scale as illustrated in FIG. 8, disorder of liquid crystals due to a transverse electric field may occur between adjacent pixels. For example, as illustrated in FIGS. 10A and 10B, when an image in which gradation is expressed in a vertical direction (hereinafter referred to simply as “gradation image”) is displayed, disorder of liquid crystals occurs in pixels in which the phase of black and white is inverted. Such disorder of liquid crystals is visually recognized by a viewer as a black line L1 illustrated in FIG. 10B. Such a black line L1 significantly deteriorates image quality.

It is desirable to provide a driving circuit in which disorder of liquid crystals is less likely to occur and a display including the driving circuit. It is also desirable to provide a method of driving a display in which disorder of liquid crystals is less likely to occur.

According to an embodiment of the present technology, there is provided a driving circuit configured to drive pixels in a display in which the pixels are disposed in a matrix, each of the pixels including a liquid crystal cell and a memory. The driving circuit includes: a dividing section dividing one frame period into a plurality of subfields, the subfields corresponding to respective bits of gray-scale data and having period lengths commensurate with weights of the corresponding bits; a correction section correcting, when bit sequences of two sets of gray-scale data corresponding to two pixels adjacent to each other differ from each other, gray-scale data having a higher gray-scale level out of the two set of gray-scale data, to further increase the gray-scale level thereof; and an ON-OFF period control section controlling a ratio of an ON period or an OFF period to one frame period by bringing the liquid crystal cell of the pixel into an on state or an off state according to a corresponding bit in each of the subfields.

According to an embodiment of the present technology, there is provided a display including a display region in which pixels each including a liquid crystal cell and a memory are disposed in a matrix, and a driving circuit driving the pixels. The driving circuit includes: a dividing section dividing one frame period into a plurality of subfields, the subfields corresponding to respective bits of gray-scale data and having period lengths commensurate with weights of the corresponding bits, a correction section correcting, when bit sequences of two sets of gray-scale data corresponding to two pixels adjacent to each other differ from each other, gray-scale data having a higher gray-scale level out of two sets of gray-scale data, to further increase the gray-scale level thereof, and an ON-OFF period control section controlling a ratio of an ON period or an OFF period to one frame period by bringing the liquid crystal cell of the pixel into an on state or an off state according to a corresponding bit in each of the subfields.

According to an embodiment of the present technology, there is provided a method of driving a display in which pixels each including a liquid crystal cell and a memory are disposed in matrix. The method includes: dividing one frame period into a plurality of subfields, the subfields corresponding to respective bits of gray-scale data and having period lengths commensurate with weights of the corresponding bits; when bit sequences of two sets of gray-scale data corresponding to two pixels adjacent to each other differ from each other, correcting gray-scale data having a higher gray-scale level out of two sets of gray-scale data, to further increase the gray-scale level thereof; and controlling a ratio of an ON period or an OFF period to one frame period by bringing the liquid crystal of the pixel into an on state or an off state according to a corresponding bit in each of the subfields.

In the driving circuit, the display, and the method of driving the display according to the embodiments of the present technology, when the bit sequences of two sets of gray-scale data corresponding to two pixels adjacent to each other differ from each other, one of the two sets of gray-scale data having a higher gray-scale level is corrected to increase the gray-scale level thereof. In this way, disorder of liquid crystals is suppressed, or the gray-scale level of the pixel having a higher gray-scale level is increased to offset decreased luminance due to disorder of liquid crystals, and thus the disorder of liquid crystals becomes less noticeable.

According to the driving circuit, the display, and the method of driving the display according to the embodiments of the present technology, disorder of liquid crystals is suppressed, or the gray-scale level of the pixel having a higher gray-scale level is increased to offset decreased luminance due to disorder of liquid crystals, and thus the disorder of liquid crystals becomes less noticeable. As a result, high image quality is realized.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a schematic view of a display according to an embodiment of the present technology.

FIG. 2 is a schematic view showing exemplary signal data defined by subfields.

FIG. 3 is a schematic view showing an exemplary phase difference between pixels adjacent to each other.

FIG. 4 is a schematic view of a conversion circuit in FIG. 1.

FIG. 5 is a flowchart showing an exemplary procedure of a gray-scale correction.

FIG. 6 shows the exemplary procedure of the gray-scale correction of FIG. 5 by bit.

FIGS. 7A to 7C are schematic views for explaining an additional correction of the above-mentioned embodiment.

FIG. 8 is a schematic view showing exemplary gray-scale data.

FIG. 9 is a schematic view showing an example of signal data and an example of selection pulses, in one frame period.

FIGS. 10A and 10B are schematic views showing an exemplary line formed in a gradation image.

### DETAILED DESCRIPTION

Referring to the figures, an embodiment of the present technology will be described in detail. Description will be given in the following order.

### 1. Embodiment (Display)

### 2. Modification (Display)

### 1. Embodiment

### [Configuration]

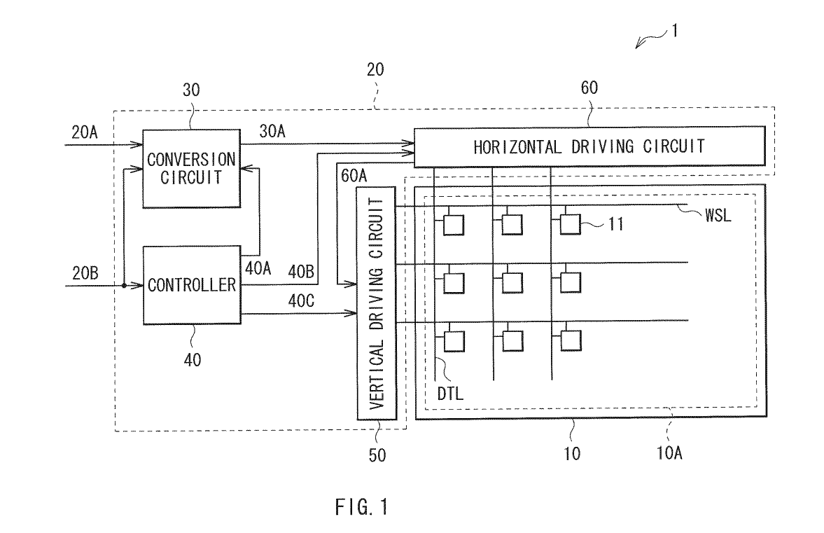

FIG. 1 shows a schematic configuration of a display 1 according to an embodiment of the present technology. The display 1 includes a display panel 10, and a peripheral circuit 20 that drives the display panel 10.

### (Display Panel 10)

The display panel 10 includes a plurality of scan lines WSL extending in a row direction, a plurality of data lines DTL extending in a column direction, and a plurality of pixels 11 disposed at locations corresponding to intersections of the scan lines WSL and the data lines DTL. The pixels 11 in the display panel 10 are two-dimensionally disposed in a row direction and a column direction all over a pixel region 10A of the display panel 10. Each pixel 11 corresponds to a dot as a minimum unit configuring a screen on the display panel 10. In the case where the display panel 10 is a color display panel, each pixel 11 corresponds to a sub pixel that emits single color light of red, green, or blue, for example, whereas in the case where the display panel 10 is a monochrome display panel, each pixel 11 corresponds to a pixel that emits monochromatic light (white light, for example).

Although not shown in the figure, each of the pixels 11 is a pixel including an electro-optical device and a memory. The electro-optical device includes liquid crystal cells. Examples of the memory include SRAMs (Static Random Access Memories) and DRAMs (Dynamic Random Access Memories). When a corresponding one of the scan lines WSL is selected, the pixel 11 is brought into a light-emitting state or a light-off state according to writing of signal data (bit) supplied to a corresponding data line DTL, and thereafter, even after the selected scan line WSL is brought into a non-selected state, the light-emitting state or the light-off state according to the writing is continued. Therefore, the peripheral circuit 20 controls the ratio of a period within which the pixel 11 is in the light-emitting state (lighting period), or a period within which the pixel 11 is in the light-off state (light-off period) to one frame period, thereby realizing a gray-scale display.

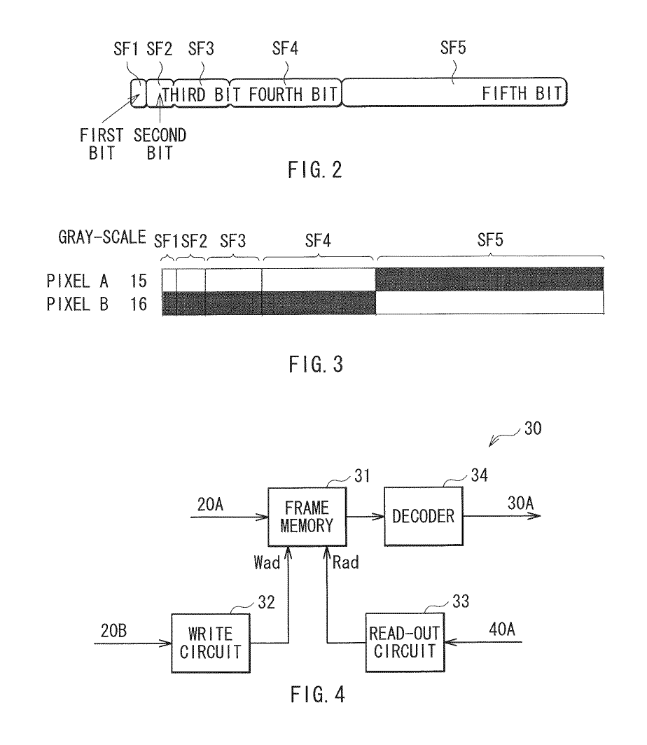

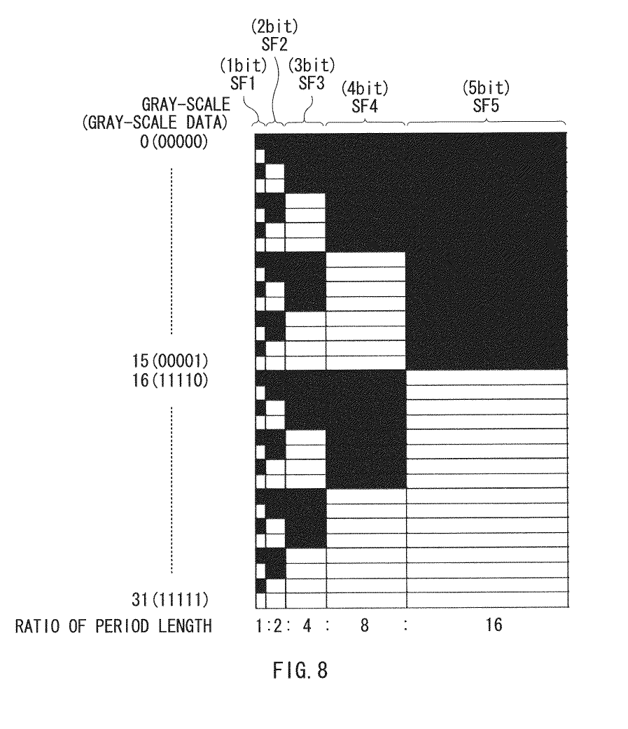

There is a concept of “subfield” as a unit of a lighting period or a light-off period of the pixels 11. “Subfield” refers to a unit which corresponds to each bit of gray-scale data defining the gray-scale of the pixels 11, and has a period length commensurate with the weight of the corresponding bit. Generally, in an exemplary case where 32 gray-scale levels are to be expressed by gray-scale data of 5 bits, as illustrated in FIG. 8 for example, with 1 bit data of several ms width taken as a unit for example, five pieces of data having a period length ratio of 1:2:4:8:16 are prepared, and 32 gray-scale levels are expressed by a combination of these five pieces of data. According to the above-mentioned gray-scale display method, as illustrated in FIG. 2, signal data is defined by subfields SF1 to SF5 corresponding to respective bits of gray-scale data (in this example, a first bit to a fifth bit), and having period lengths commensurate with the weights of the corresponding bits.

In the above-mentioned gray-scale display method, in the case where a gradation image is displayed for example, a portion typically exists in which the bit sequences of two sets of gray-scale data corresponding to two pixels 11 adjacent to each other differ from each other. For example, in the case where a pixel A has a gray-scale level of 15 and a pixel B adjacent to the pixel A has a gray-scale level of 16 as illustrated in FIG. 3, the phases (of black and white) are different from each other in all bits. In the case where the phases of pixels adjacent to each other differ from each other as described, disorder of liquid crystals may occur. In this case, gray-scale data having a higher gray-scale level is corrected to increase the gray-scale level thereof. For example, in the example illustrated in FIG. 3, since the gray-scale level of the pixel B is higher than that of the pixel A, the gray-scale data corresponding to the pixel B is corrected to increase the gray-scale level thereof. In this way, disorder of liquid crystals is suppressed, or the gray-scale level of the pixel having a higher gray-scale level is increased to offset decreased luminance due to disorder of liquid crystals, and thus the disorder of liquid crystals becomes less noticeable.

### (Peripheral Circuit 20)

Next, a configuration of the peripheral circuit 20 is described. As illustrated in FIG. 1, the peripheral circuit 20 includes a conversion circuit 30, a controller 40, a vertical driving circuit 50, and a horizontal driving circuit 60, for example.

The controller 40 generates, from a synchronization signal 20B supplied from a higher device not shown in the figure, control signals 40A, 40B, and 40C intended to control operation timings of the conversion circuit 30, the vertical driving circuit 50, and the horizontal driving circuit 60. Examples of the synchronization signal 20B include a vertical synchronization signal, a horizontal synchronization signal, and a dot clock signal. Examples of the control signals 40A, 40B, and 40C include a clock signal, a latch signal, a frame start signal, and a subfield start signal.

As illustrated in FIG. 4, the conversion circuit 30 includes a frame memory 31, a write circuit 32, a read-out circuit 33, and a decoder 34, for example. The frame memory 31 is a memory for image display having storage capacity at least greater than the resolution of the display region 10A, and is capable of storing row addresses, column addresses, and gray-scale data of the pixels 11 associated with the row addresses and the column addresses, for example. The write circuit 32 utilizes the synchronization signal 20B to generate a write address Wad of a video signal 20A, and, in synchronization with the synchronization signal 20B, outputs the write address Wad to the frame memory 31. The write address Wad includes a row address and a column address, for example. Based on the control signal 40A, the read-out circuit 33 generates a read-out address Rad, and outputs the read-out address Rad to the frame memory 31. The decoder 34 outputs gray-scale data outputted from the frame memory 31 as signal data 30A.

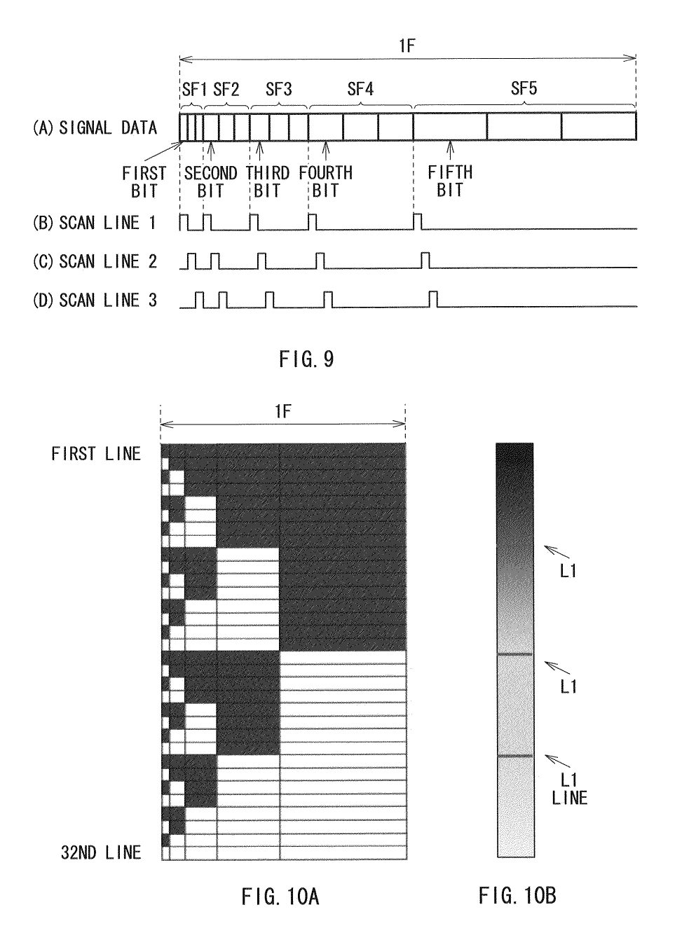

Based on a control signal 60A (described later) inputted from the horizontal driving circuit 60 and address data specified by the control signal 40C, the vertical driving circuit 50 outputs, to the scan line WSL, a scan pulse intended to select each pixel 11 on a row by row basis. For example, as illustrated in (A) to (D) of FIG. 9, the vertical driving circuit 50 sequentially outputs a selection pulse to each scan line WSL according to the order and period lengths of SF1, SF2, SF3, SF4, and SF5.

Based on the control signal 40B and the signal data 30A, the horizontal driving circuit 60 brings the electro-optical devices of the pixels 11 into an on state or an off state, and thus controls a ratio of ON period or OFF period to 1F stepwisely.

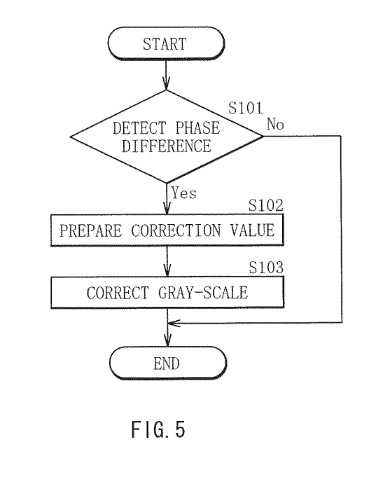

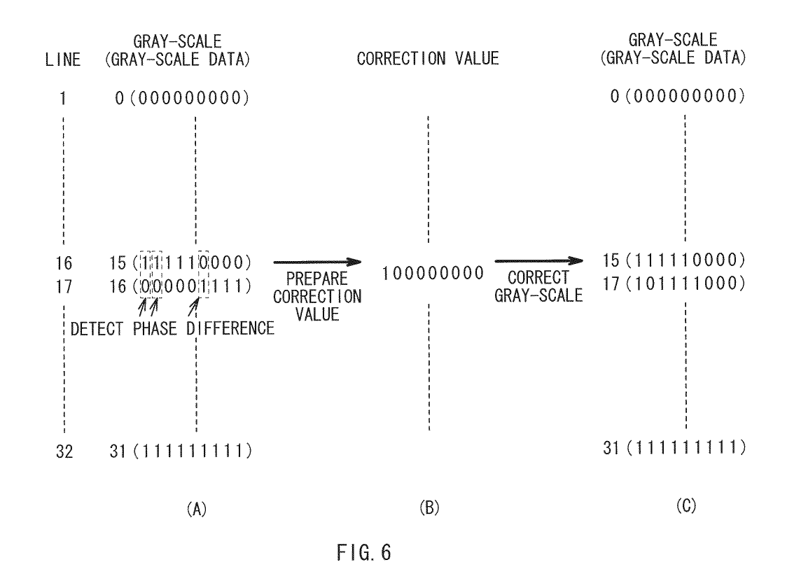

The horizontal driving circuit 60 corrects the bit sequence of the signal data 30A (gray-scale data) to obtain a desired bit sequence. FIG. 5 is a flowchart showing an exemplary procedure in which the bit sequence of the signal data 30A is corrected to obtain a desired bit sequence. FIG. 6 shows an example of the above-mentioned correction in the case where the signal data 30A is gray-scale data for displaying gradation in a vertical direction.

First, the horizontal driving circuit 60 detects, in each shared subfield, presence or absence of phase difference in two sets of gray-scale data corresponding to two pixels adjacent to each other in the signal data 30A (S101). In this instance, the term “phase difference” means a difference of bits or a difference of black and white. Then, when no phase difference is detected, the horizontal driving circuit 60 does not execute the above-mentioned additional correction, and ends the correction. On the other hand, when a phase difference is detected as illustrated in (A) of FIG. 6, for example, the horizontal driving circuit 60 prepares a correction value for the gray-scale data having a higher gray-scale level (S102). The horizontal driving circuit 60 prepares gray-scale data of gray-scale level of 1 as a correction value as illustrated in (B) of FIG. 6, for example. It is to be noted that, the correction value is not necessarily limited to the gray-scale data of gray-scale level of 1. Thereafter, the horizontal driving circuit 60 corrects the gray-scale level of the gray-scale data having a higher gray-scale level (S103). The horizontal driving circuit 60 adds the gray-scale data of gray-scale level of 1 to the gray-scale data having a higher gray-scale level as illustrated in (C) of FIG. 6, for example. In this way, the gray-scale data having a higher gray-scale level is corrected to increase the gray-scale level thereof. As a result, disorder of liquid crystals is suppressed, or the gray-scale level of the pixel having a higher gray-scale level is increased to offset decreased luminance due to disorder of liquid crystals, and thus the disorder of liquid crystals becomes less noticeable.

In addition, the horizontal driving circuit 60 outputs the control signal 60A corresponding to the order and period lengths of subfields of the corrected signal data 30A to the vertical driving circuit 50.

### [Effect]

Next, in comparison with known general digital driving, an effect of the display 1 according to the present embodiment is described.

In digital displays that perform gray-scale display by PWM, a gray-scale display method as illustrated in FIG. 8 is used in an exemplary case of 5 bits (32 gray-scale levels), for example. Specifically, as illustrated in FIG. 8, with 1 bit data of several ms width taken as a unit for example, five pieces of data having a period length ratio of 1:2:4:8:16 are prepared, and 32 gray-scale levels are expressed by a combination of these five pieces of data.

FIG. 9 shows a relationship between signal data of sequential scanning and selection pulses applied to scan lines in known general digital driving. FIG. 9 shows a case of three scan lines for convenience of description. As is clear from FIG. 9, in a known general digital display, one frame period (1F) is divided into subfields SF1 to SF5 corresponding to respective bits (in this example, a first bit to a fifth bit) of gray-scale data, and having period lengths commensurate with the weights of the corresponding bits. In this configuration, an electro-optical device of a pixel is turned on or off according to the corresponding bit in each of the subfields SF1 to SF5, and thus a ratio of ON period or OFF period to 1F is stepwisely controlled. Further, data is written in pixels through scan lines by line-sequential scanning in each of the subfields SF1 to SF5.

Incidentally, in the case where a gray-scale display method is used in which a phase of black and white is inverted according to a small difference of gray-scale as illustrated in FIG. 8, disorder of liquid crystals due to a transverse electric field may occur between adjacent pixels. For example, as illustrated in FIGS. 10A and 10B, when a gradation image is displayed, disorder of liquid crystals occurs in pixels in which the phase of black and white is inverted. Such disorder of liquid crystals is visually recognized by a viewer as a black line L1 illustrated in FIG. 10B. Such a black line L1 significantly deteriorates image quality.

On the other hand, in the present embodiment, when the bit sequences of two sets of gray-scale data corresponding to two pixels 11 adjacent to each other differ from each other, one of the two sets of gray-scale data having a higher gray-scale level is corrected to increase the gray-scale level thereof. In this way, disorder of liquid crystals is suppressed, or the gray-scale level of the pixel having a higher gray-scale level is increased to offset decreased luminance due to disorder of liquid crystals, and thus the disorder of liquid crystals becomes less noticeable. As a result, high image quality is realized.

### 2. Modification

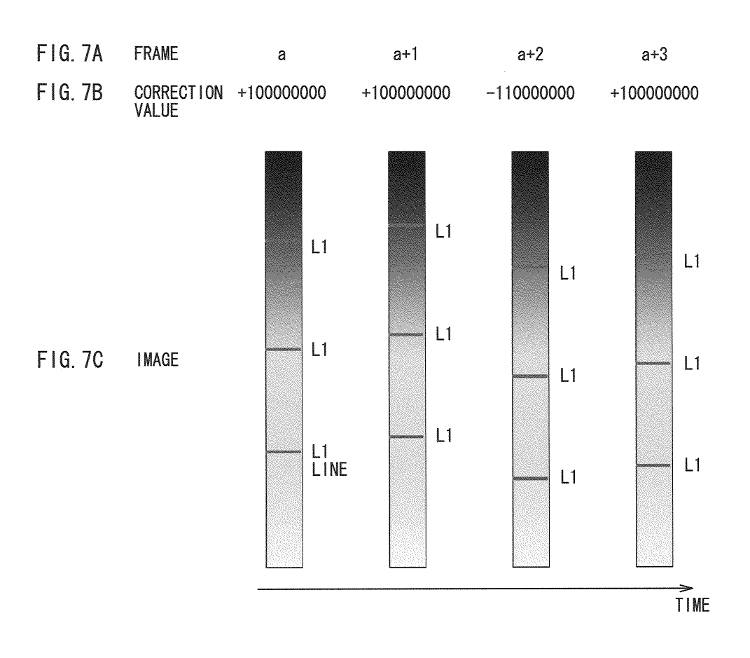

Incidentally, in the above-mentioned embodiment, it is also possible that the horizontal driving circuit 60 adds a correction value common to all pixels to the signal data 30A corresponding to all pixels on a frame by frame basis, and periodically changes the correction value. For example, as illustrated in FIGS. 7A to 7C, it is also possible that the horizontal driving circuit 60 adds in order and repeatedly

+100000000 (gray-scale data for increasing gray-scale level by 1)

+100000000 (gray-scale data for increasing gray-scale level by 1)

−010000000 (gray-scale data for decreasing gray-scale level by 3)

+100000000 (gray-scale data for increasing gray-scale level by 1)

to the signal data 30A corresponding to all pixels on a frame by frame basis. In the case where such a configuration is adopted, as illustrated in FIG. 7C, the lines L1 formed by disorder of liquid crystals oscillate on an image display screen in a time dependent manner with a predetermined amplitude, and therefore the lines L1 are less likely to be visually recognized by a viewer. In this way, high image quality is realized.

Hereinabove, while the present technology has been described based on the embodiment and the modification, the present technology is not limited to the above-mentioned embodiment and so forth, and various modifications may be made.

For example, while the controller 40 controls the driving of the conversion circuit 30, the vertical driving circuit 50, and the horizontal driving circuit 60 in the above-mentioned embodiment and so forth, other circuits may control the driving. In addition, the control of the conversion circuit 30, the vertical driving circuit 50, and the horizontal driving circuit 60 may be performed by hardware (circuit) as well as by software (program).

Note that the technology may be configured as follows.

(1) A driving circuit configured to drive pixels in a display in which the pixels are disposed in a matrix, each of the pixels including a liquid crystal cell and a memory, the driving circuit including:

a dividing section dividing one frame period into a plurality of subfields, the subfields corresponding to respective bits of gray-scale data and having period lengths commensurate with weights of the corresponding bits;

a correction section correcting, when bit sequences of two sets of gray-scale data corresponding to two pixels adjacent to each other differ from each other, gray-scale data having a higher gray-scale level out of the two set of gray-scale data, to further increase the gray-scale level thereof; and

an ON-OFF period control section controlling a ratio of an ON period or an OFF period to one frame period by bringing the liquid crystal cell of the pixel into an on state or an off state according to a corresponding bit in each of the subfields.

(2) The driving circuit according to (1), wherein, on a frame by frame basis, the correction section adds a correction value common to all pixels to gray-scale data corresponding to all pixels, and periodically changes the correction value.

(3) A display including a display region in which pixels each including a liquid crystal cell and a memory are disposed in a matrix, and a driving circuit driving the pixels, the driving circuit including:

a dividing section dividing one frame period into a plurality of subfields, the subfields corresponding to respective bits of gray-scale data and having period lengths commensurate with weights of the corresponding bits,

a correction section correcting, when bit sequences of two sets of gray-scale data corresponding to two pixels adjacent to each other differ from each other, gray-scale data having a higher gray-scale level out of two sets of gray-scale data, to further increase the gray-scale level thereof, and

an ON-OFF period control section controlling a ratio of an ON period or an OFF period to one frame period by bringing the liquid crystal cell of the pixel into an on state or an off state according to a corresponding bit in each of the subfields.

(4) A method of driving a display in which pixels each including a liquid crystal cell and a memory are disposed in matrix, the method including:

dividing one frame period into a plurality of subfields, the subfields corresponding to respective bits of gray-scale data and having period lengths commensurate with weights of the corresponding bits;

when bit sequences of two sets of gray-scale data corresponding to two pixels adjacent to each other differ from each other, correcting gray-scale data having a higher gray-scale level out of two sets of gray-scale data, to further increase the gray-scale level thereof; and

controlling a ratio of an ON period or an OFF period to one frame period by bringing the liquid crystal of the pixel into an on state or an off state according to a corresponding bit in each of the subfields.

The present disclosure contains subject matter related to that disclosed in Japanese Priority Patent Application JP 2011-189926 filed in the Japan Patent Office on Aug. 31, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A driving circuit configured to drive pixels in a display in which the pixels are disposed in a matrix, each of the pixels including a liquid crystal cell and a memory, the driving circuit comprising:
a dividing section dividing one frame period into a plurality of subfields, the subfields corresponding to respective bits of gray-scale data and having period lengths commensurate with weights of the corresponding bits;
a correction section correcting, when bit sequences of two sets of gray-scale data corresponding to two pixels adjacent to each other differ from each other, gray-scale data having a higher gray-scale level out of the two set of gray-scale data, to further increase the gray-scale level thereof; and
an ON-OFF period control section controlling a ratio of an ON period or an OFF period to one frame period by bringing the liquid crystal cell of the pixel into an on state or an off state according to a corresponding bit in each of the subfields.

2. The driving circuit according to claim 1, wherein, on a frame by frame basis, the correction section adds a correction value common to all pixels to gray-scale data corresponding to all pixels, and periodically changes the correction value.

3. A display including a display region in which pixels each including a liquid crystal cell and a memory are disposed in a matrix, and a driving circuit driving the pixels, the driving circuit comprising:
a dividing section dividing one frame period into a plurality of subfields, the subfields corresponding to respective bits of gray-scale data and having period lengths commensurate with weights of the corresponding bits,
a correction section correcting, when bit sequences of two sets of gray-scale data corresponding to two pixels adjacent to each other differ from each other, gray-scale data having a higher gray-scale level out of two sets of gray-scale data, to further increase the gray-scale level thereof, and
an ON-OFF period control section controlling a ratio of an ON period or an OFF period to one frame period by bringing the liquid crystal cell of the pixel into an on state or an off state according to a corresponding bit in each of the subfields.

4. A method of driving a display in which pixels each including a liquid crystal cell and a memory are disposed in matrix, the method comprising:
dividing one frame period into a plurality of subfields, the subfields corresponding to respective bits of gray-scale data and having period lengths commensurate with weights of the corresponding bits;
when bit sequences of two sets of gray-scale data corresponding to two pixels adjacent to each other differ from each other, correcting gray-scale data having a higher gray-scale level out of two sets of gray-scale data, to further increase the gray-scale level thereof; and
controlling a ratio of an ON period or an OFF period to one frame period by bringing the liquid crystal of the pixel into an on state or an off state according to a corresponding bit in each of the subfields.
